(19) United States
(12) Patent Application Publication
(10) Pub. No.: US 2016/0262108 A1
(43) Pub. Date: Sep. 8, 2016

(54) CONTEXTUAL POWER MANAGEMENT

(71) Applicants: John C. WEAST, Portland, OR (US); Timothy J. GRESHAM, Portland, OR (US); Corey KUKIS, Beaverton, OR (US)

(72) Inventors: John C. WEAST, Portland, OR (US); Timothy J. GRESHAM, Portland, OR (US); Corey KUKIS, Beaverton, OR (US)

(21) Appl. No.: 14/916,771

(22) PCT Filed: Nov. 27, 2013
(86) PCT No.: PCT/US2013/072320

§ 371 Date: Mar. 4, 2016

(51) Int. Cl. H04W 52/02; H04M 1/725; G06F 1/32

(52) U.S. Cl. CPC H04W 52/0258; G06F 1/3203; G06F 1/3212; G06F 1/3287; G06F 1/3265; H04M 1/72569

(57) ABSTRACT

Technologies for regulating power consumption include a mobile computing device to generate a power profile based on historical power usage data of the mobile computing device. The mobile computing device determines a power usage context of the mobile computing device and estimates a future power consumption of the mobile computing device based on at least one of the power profile or the power usage context. The mobile computing device regulates a power consumption of the mobile computing device based on the estimated future power consumption.

### BACKGROUND

Smartphones and other mobile computing devices have become an integral part of the lives of many people. For example, in a typical day, any given person may use his or her mobile computing device to answer calls, check email and voice messages, transmit text messages, research a topic on the internet, execute various applications, and/or use Global Positioning System (GPS) circuitry to provide navigation services. In order to perform such a wide array of functions, mobile computing devices are generally equipped with interfaces, sensors, and other components while maintaining a small physical form.

Normal operation of a mobile computing device involves providing power to a multitude of components of the device to, for example, run numerous applications and utilize various features. In many cases, power is continuously delivered to components of the mobile computing device to keep those components “at the ready” in the event they are needed, which reduces boot time and enhances the user's experience. However, battery power, which is very limited due to the typically small size of mobile computing devices, is oftentimes depleted fairly quickly. As such, users often find themselves with a “dead” phone but a need to use the phone (e.g., for GPS navigation in an unfamiliar city).

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a mobile computing device for contextual power management;

FIG. 2 is a simplified block diagram of at least one embodiment of an environment of the mobile computing device of FIG. 1;

FIGS. 3 and 4 is a simplified flow diagram of at least one embodiment of a method for regulating power consumption of the mobile computing device of FIG. 1;

FIG. 5 is a simplified flow diagram of at least one embodiment of a method for handling the charging of the mobile computing device of FIG. 1; and

FIGS. 6A and 6B are diagrams of a long-term power profile and a short-term power profile of the mobile computing device of FIG. 1, respectively.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

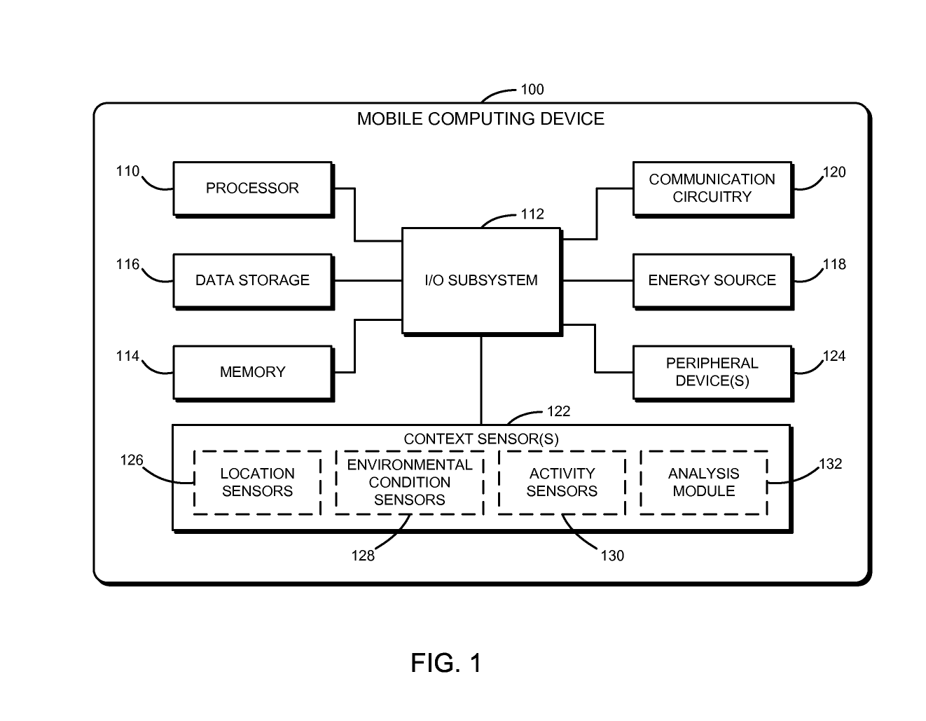

Referring now to FIG. 1, a mobile computing device 100 is configured to regulate power consumption by modifying the power consumption of one or more components of the mobile computing device 100 prior to the mobile computing device 100 reaching a critically low power level. To do so, the mobile computing device 100 generates a power profile of the mobile computing device 100 based on historical power usage data of the mobile computing device 100 and determines a power usage context of the mobile computing device 100. In the illustrative embodiment, the mobile computing device 100 estimates the future power consumption of the mobile computing device 100 based on the generated power profile and/or the power usage context, which is used to regulate the power consumption of the mobile computing device 100.

The mobile computing device 100 may be embodied as any type of computing device capable of regulating power consumption and performing the functions described herein. For example, the mobile computing device 100 may be embodied as a cellular phone, smartphone, tablet computer, netbook, notebook, ultrabook™, laptop computer, personal digital assistant, mobile Internet device, desktop computer, Hybrid device, and/or any other computing/communication device. As shown in FIG. 1, the illustrative mobile computing device 100 includes a processor 110, an input/output (“I/O”) subsystem 112, a memory 114, a data storage 116, an energy source 118, a communication circuitry 120, one or more context sensors 122, and one or more peripheral devices 124. Of course, the mobile computing device 100 may include other or additional components, such as those commonly found in a typical computing device (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the mobile computing device 100 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the mobile computing device 100. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the mobile computing device 100, on a single integrated circuit chip.

The data storage 116 may be embodied as any type of device or devices configured for short-term or long-term storage of data such as, for example, memory devices and circuits, memory cards, hard disk drives, solid-state drives, or other data storage devices. The data storage 116 may store various data during operation of the mobile computing device 100 such as, for example, determined context data, power profiles, historical power usage, and/or other data useful in the operation of the mobile computing device 100 as discussed below.

The energy source 118 of the mobile computing device 100 may be embodied as any device or component capable of providing power to other components of the mobile computing device 100, being recharged, and otherwise performing the functions described herein. For example, in the illustrative embodiment, the energy source 118 is embodied as a rechargeable battery, such as a lithium-ion battery. Of course, in other embodiments, additional and/or other types of rechargeable energy sources may be used.

The communication circuitry 120 may be embodied as any type of communication circuit, device, or collection thereof, capable of enabling communications between the mobile computing device 100 and other remote devices over a network (not shown). To do so, the communication circuitry 120 may use any suitable communication technology (e.g., wireless or wired communications) and associated protocol (e.g., Ethernet, Bluetooth®, Wi-Fi®, WiMAX, etc.) to effect such communication depending on, for example, the type of network, which may be embodied as any type of communication network capable of facilitating communication between the mobile computing device 100 and remote devices.

The context sensors 122 collect data regarding a user of the mobile computing device 100, the environment of the mobile computing device 100, the mobile computing device 100 itself, and/or other data useful in the determination of the power usage context of the mobile computing device 100 as discussed below. In various embodiments, the context sensors 122 may be embodied as, or otherwise include, for example, proximity sensors, optical sensors, light sensors, audio sensors, temperature sensors, motion sensors, piezoelectric sensors, and/or other types of sensors. Of course, the mobile computing device 100 may also include components and/or devices configured to facilitate the use of the context sensors 122. More specifically, as shown in the illustrative embodiment, the context sensors 122 may include one or more location sensors 126, environmental condition sensors 128, activity sensors 130, and/or analysis modules 132.

The location sensors 126 may be embodied as any type of sensors, devices, components, and/or circuitry capable of determining the location of the mobile computing device 100. For example, the location sensors 126 may be embodied as, or otherwise include, GPS circuitry capable of determining the absolute geographical position of the mobile computing device 100. In some embodiments, the mobile computing device 100 may use the location sensors 126 to determine the location of the mobile computing device 100 relative to another device, which may be used to determine, for example, the absolute position of the mobile computing device 100. That is, in some embodiments, the mobile computing device 100 may implement triangulation and/or trilateration algorithms and techniques to determine the position of the mobile computing device 100 based on data generated by the location sensors 126 (e.g., using distances and/or angles to cellular network towers with known geographical positions).

The environmental condition sensors 128 may be embodied as any type of sensors, devices, components, and/or circuitry capable of producing data indicative of the surrounding environment of the mobile computing device 100. For example, in some embodiments, the environmental condition sensors 128 may sense characteristics of the physical environment of the mobile computing device 100 such as temperature, moisture, light, audio levels, and other physical characteristics.

The activity sensors 134 are configured to sense, or otherwise determine or infer, activities with which the user of the mobile computing device 100 is engaged. For example, the activity sensors 134 may sense whether the mobile computing device 100 (and likely therefore the user) is moving or stationary. The activity sensors 134 may include inertial sensors (e.g., accelerometers and gyroscopes), location sensors, and/or other sensors capable of generating data useful in determining the activity of the user and/or the mobile computing device 100.

The analysis module 132 may be embodied as any type of devices, hardware and/or software components, and/or circuitry capable of analyzing data stored on the mobile computing device 100. For example, as discussed below, the analysis module 132 may analyze the user's calendar schedule information, historical call, text, e-mail, or other contact information, the current and future location of the mobile computing device 100 (e.g., based on locations of appointments), and/or other information stored on the mobile computing device 100 (e.g., use pattern information) to determine a power usage context of the mobile computing device 100. Of course, it should be appreciated that the context sensors 122 may cooperate together to more accurately sensor or determine the context of the mobile computing device 100.

In some embodiments, the mobile computing device 100 may also include one or more peripheral devices 124. The peripheral devices 124 may include any number of additional peripheral or interface devices (e.g., a display). The particular devices included in the peripheral devices 124 may depend on, for example, the type and/or intended use of the mobile computing device 100.

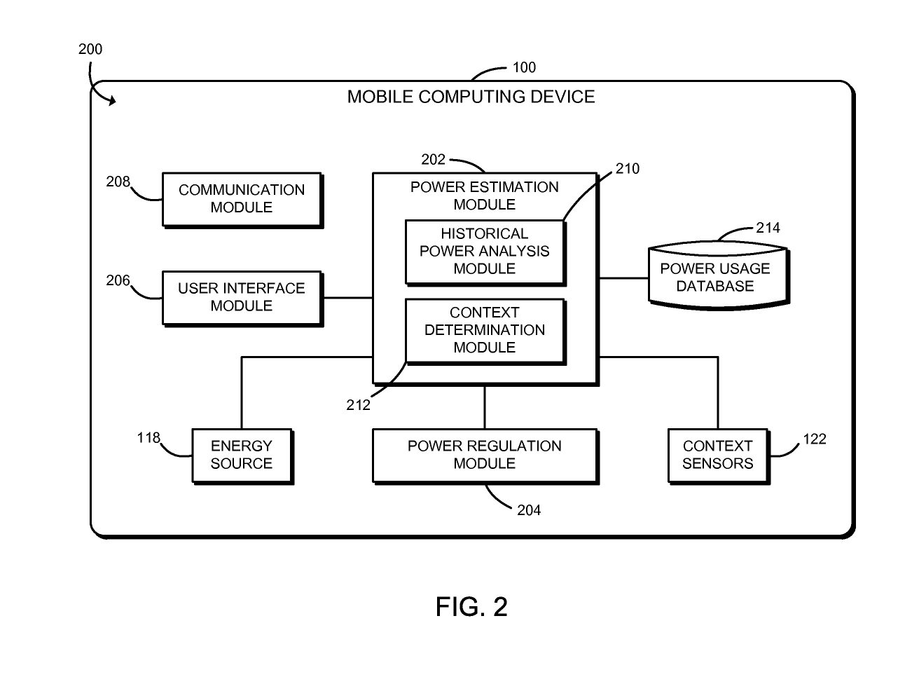

Referring now to FIG. 2, in use, the illustrative mobile computing device 100 establishes an environment 200 for contextual power management. As discussed below, the mobile computing device 100 “aggressively” regulates power consumption of the components of the mobile computing device 100 prior to the energy source 118 of the mobile computing device 100 reaching a critically low power level. The illustrative environment 200 of the mobile computing device 100 includes a power estimation module 202, a power regulation module 204, a user interface module 206, and a communication module 208. Additionally, the power estimation module 202 includes a historical power analysis module 210 and a context determination module 212. Each of the power estimation module 202, the power regulation module 204, the user interface module 206, the communication module 208, the historical power analysis module 210, and the context determination module 212 may be embodied as hardware, software, firmware, or a combination thereof Additionally, in some embodiments, one or more of the illustrative modules may form a portion of another module.

The power estimation module 202 estimates the future power consumption of the mobile computing device 100 based on one or more generated power profiles and/or determined power usage context of the mobile computing device 100. The power profiles may be generated based on, for example, instantaneous power usage data collected from the energy source 118 and/or historical power usage data stored in a power usage database 214 of the mobile computing device 100. The power estimation module 202 may retrieve and/or generate power usage data based on the power levels of the energy source 118 at different points in time, the state of the mobile computing device 100 at different points in time, and/or other power usage characteristics of the mobile computing device 100 and may update the power usage database 214 with such data (e.g., raw power usage data or derived power usage data). The power usage database 214 may be embodied as any suitable data structure for storing such information (e.g., a database).

The historical power analysis module 210 generates one or more power profiles of the mobile computing device 100 based on historical power usage data (e.g., data retrieved from the power usage database 214). In other embodiments, the power profile(s) are pre-generated (e.g., by the mobile computing device 100 or a remote computing device) and stored in the power usage database 214 for retrieval by the historical power analysis module 210. As discussed in more detail below, the historical power analysis module 210 may generate a long-term power profile and a short-term power profile of the mobile computing device 100. For example, the historical power analysis module 210 may generate a long-term power profile indicative of a historical pattern of energy usage of the mobile computing device 100 (e.g., the average power consumption of the mobile computing device 100 or an average amount of energy remaining in the energy source 118 at different times of day). Additionally, the historical power analysis module 210 may generate a short-term profile indicative of energy/power usage of the mobile computing device 100 since a particular point in time (e.g., since the start of the day, since the mobile computing device 100 was last at full charge, since a point in time in which the rate of energy loss/gain changed, etc.). As discussed below, in some embodiments, the historical power analysis module 210 compares the long-term power profile to the short-term power profile to determine, for example, deviations or anomalies in power usage based on the user's historical pattern of power usage.

The context determination module 212 determines the power usage context of the mobile computing device 100 based on, for example, data received from the context sensors 122. That is, the context determination module 212 analyzes various characteristics of the mobile computing device 100, data stored on the mobile computing device 100, and/or other contextual information related to power usage and/or consumption to determine a power usage context of the mobile computing device 100. For example, the context determination module 212 may determine the power usage context of the mobile computing device 100 by analyzing a schedule stored on the mobile computing device 100, the location of the mobile computing device 100, an activity performed on the mobile computing device 100 or by a user of the mobile computing device 100, and/or an environmental condition of the mobile computing device 100.

The power regulation module 204 regulates a power consumption of the mobile computing device 100 based on the estimated future power consumption of the mobile computing device 100. In the illustrative embodiment, the power regulation module 204 modifies (e.g., reduces) the power consumption of the mobile computing device 100 if it is determined that the mobile computing device 100 has insufficient power to last until a predetermined point in time (e.g., a typical time the user arrives home, a typical time the mobile computing device 100 is plugged in to be charged for the evening/night, or some other temporal reference point). To do so, the power regulation module 204 may modify the power consumption of the components of the mobile computing device 100. For example, in one embodiment, the power regulation module 204 may regulate the power consumption of the mobile computing device 100 by turning off ancillary devices of the mobile computing device 100 (e.g., GPS circuitry), adjusting the brightness of a display of the mobile computing device 100, and/or modifying a timeout period of the display of the mobile computing device 100. In the illustrative embodiment, the power regulation module 204 modifies the power consumption of the mobile computing device 100 without user intervention; however, in other embodiments, the power regulation module 204 may modify the power consumption of various components of the mobile computing device 100 based on user input. For example, the user may opt to turn off the GPS and/or podcast downloads to conserve power. Accordingly, the mobile computing device 100 is configured to preemptively respond to a low power condition to reduce the likelihood of a situation in which the mobile computing device 100 is needed but is out of power.

The user interface module 206 permits a user to interact with the mobile computing device 100. For example, the user may interact with the mobile computing device 100 to regulate power consumption of the mobile computing device 100 (e.g., by selecting components of the mobile computing device 100 for which to reduce power consumption). As such, in some embodiments, the mobile computing device 100 includes one or more virtual and/or physical buttons, knobs, switches, keypads, touchscreens, and/or other mechanisms to permit I/O functionality. Additionally, in the illustrative embodiment, the user interface module 206 is configured to transmit alert messages to the user of the mobile computing device 100. For example, as discussed below, the user interface module 206 may transmit an alert message to the user if the energy source 118 of the mobile computing device 100 has reached a power level so low that the mobile computing device 100 must be charged to maintain power until a predetermined point in time (e.g., a typical time the user arrives home, a typical time the mobile computing device 100 is plugged in to be charged for the evening/night, etc.). The user interface module 206 may also transmit an alert message to the user if the mobile computing device 100 is charging and the energy source 118 of the mobile computing device 100 has reached an energy level such that the mobile computing device 100 has sufficient power to last until a predetermined point in time.

The communication module 208 handles the communication between the mobile computing device 100 and remote devices through a network. As indicated above, in some embodiments, a remote computing device may analyze the power usage data of the mobile computing device 100 (e.g., to generate a historical power profile). Accordingly, in such embodiments, the mobile computing device 100 may receive the results of the analysis from the remote computing device via the communication module 208.

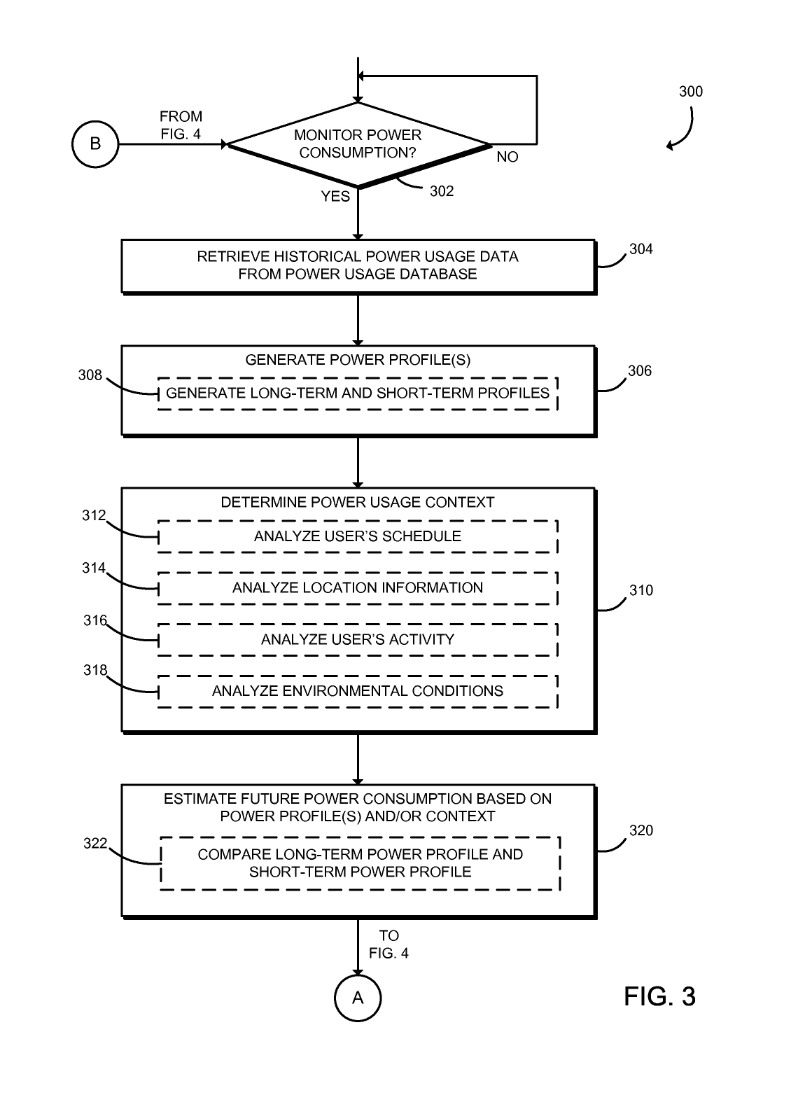

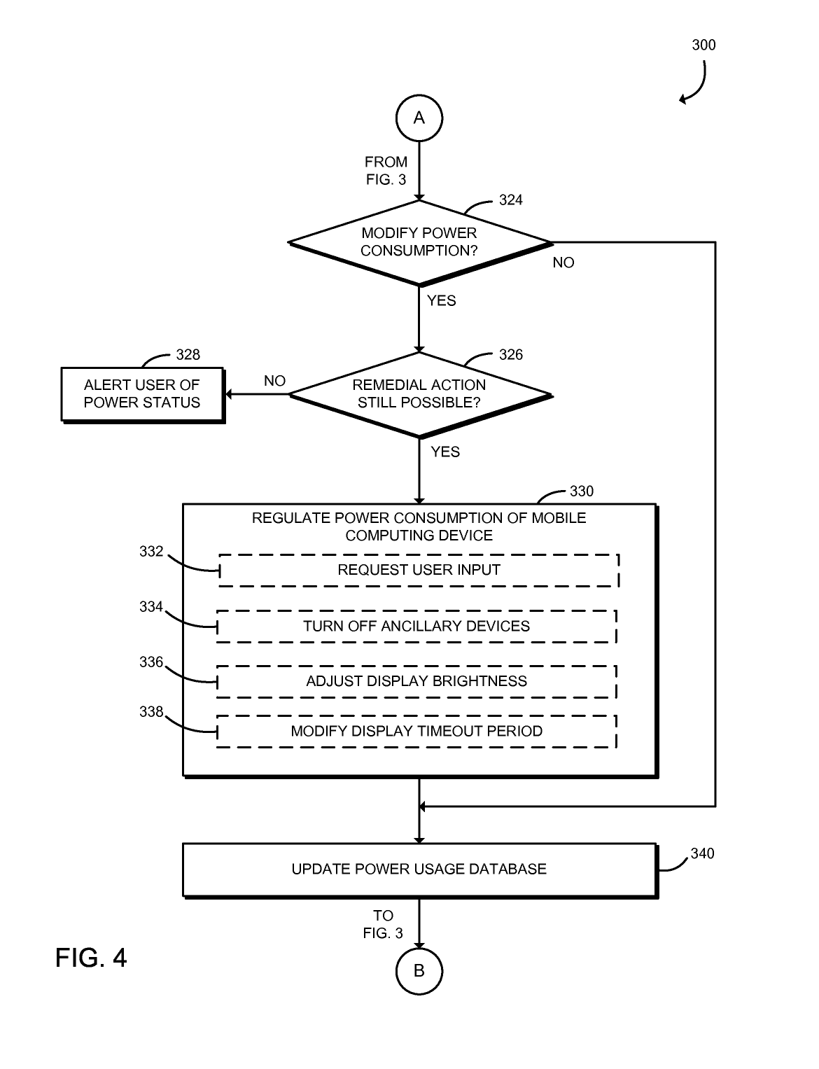

Referring now to FIGS. 3 and 4, in use, the mobile computing device 100 may execute a method 300 for regulating power consumption. The illustrative method 300 begins with block 302 of FIG. 3 in which the mobile computing device 100 determines whether to monitor power consumption (i.e., for regulating power consumption). If so, the mobile computing device 100 retrieves historical power usage data from the power usage database 214 in block 304. As discussed above, the historical power usage data may include instantaneous power usage data captured by the mobile computing device 100 over time and stored in the power usage database 214. It should be appreciated that the power usage data may provide, for example, “snapshots” of the power consumption of one or more components of the mobile computing device 100 (e.g., of each component), the power/energy level of the energy source 118 of the mobile computing device 100, and/or other power usage data at various points in time. Additionally, depending on the particular embodiment, the power usage data may include or be expressed as raw data, derived data, absolute-valued data, relative-valued data, ratios, percentages, and/or in any suitable format.

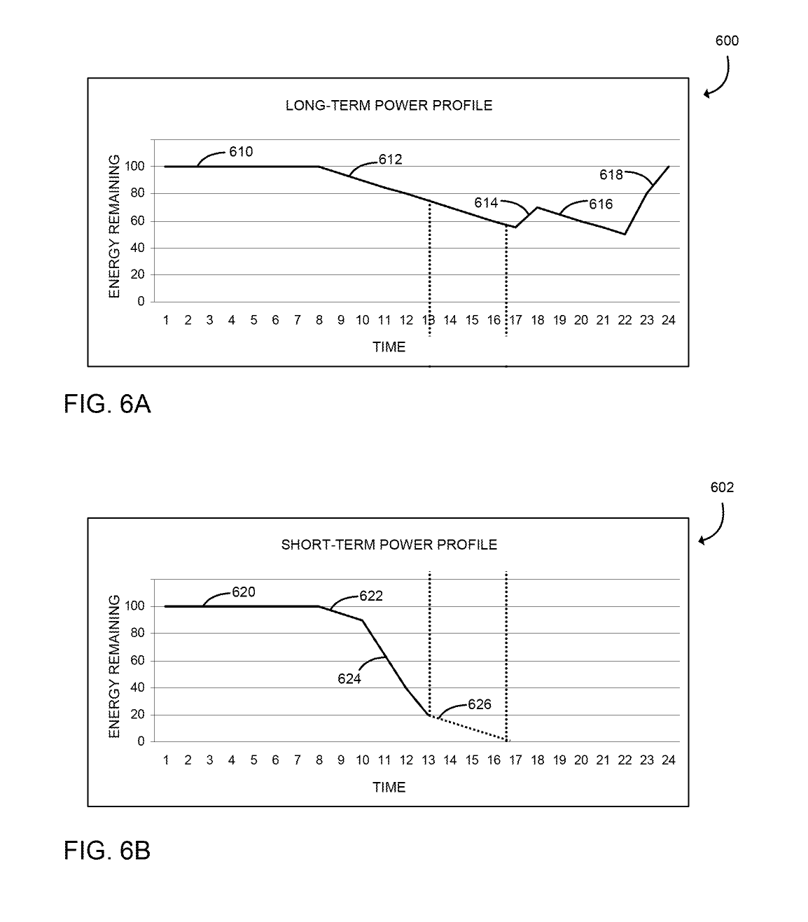

In block 306, the mobile computing device 100 generates one or more power profiles of the mobile computing device 100 (e.g., based on the historical power usage data). In doing so, the mobile computing device 100 may generate a long-term power profile (see FIG. 6A) and a short-term power profile (see FIG. 6B) in block 308. For example, as discussed above, the mobile computing device 100 may generate a long-term power profile indicative of a historical pattern of energy usage of the mobile computing device 100. Additionally, the mobile computing device 100 may generate a short-term profile indicative of energy/power usage of the mobile computing device 100 since a particular point in time (e.g., since the start of the day, since the mobile computing device 100 was last at full charge, since a point in time in which the rate of energy loss/gain changed, etc.).

It should be appreciated that the power profiles may be generated in any suitable format for representing and/or analyzing the power consumption of the mobile computing device 100. In the illustrative embodiment, the long-term historical power profile indicates the average power consumption of the mobile computing device 100 taken over a period of time defined by the points of time with which the analyzed instantaneous power usage data (i.e., power usage data) corresponds. More specifically, the long-term power profile may indicate an average amount of energy remaining in the energy source 118 of the mobile computing device 100 at different times of day (e.g., at each hour in a twenty-four hour period). The mobile computing device 100 may utilize any suitable algorithms or techniques to generate such a power profile. For example, the profile may be generated based on an arithmetic mean, weighted average (e.g., linearly weighted average, exponentially weighted average, or average weighted based on some other suitable weighting function), or another suitable metric for indicating typicality.

In block 310, the mobile computing device 100 determines the power usage context of the mobile computing device 100. As indicated above, in doing so, the mobile computing device 102 may analyze the user's schedule in block 312, analyze location information in block 314, analyze the user's activity in block 316, analyze environmental conditions of the mobile computing device 100 in block 318, and/or analyze other data or information useful in determining the power usage context of the mobile computing device. It should be appreciated that the mobile computing device 100 may utilize the power usage data to determine a pattern of use or other contextual information. For example, the mobile computing device 100 may determine that the general pattern of use of the mobile computing device 100 involves charging the phone at night, daily activities throughout the day (e.g., based on the user's schedule, activity, etc.), a daily commute in the evening (e.g., based on the location and/or charging the mobile computing device 100 via a car charger), and arrival at home at night (e.g., based on location, charging the phone, the user's schedule, etc.). The mobile computing device 100 recognizes a deviation from such a pattern of usage. For example, based on the typical pattern of use, the mobile computing device 100 may recognize that the user has an atypical evening appointment, the user is a different distance away from home than is typical, the user is receiving directions via GPS navigation, and/or the user was in a conference throughout the day.

It should further be appreciated that one or more of the power profiles may include or otherwise be associated with the context of the mobile computing device 100 (e.g., at various points in time) and/or a user of the mobile computing device 100. That is, in some embodiments, the power profiles may not only relate the energy/power of the mobile computing device 100 to different points in time but also to other characteristics of the mobile computing device 100 (e.g., locations, activities, and/or other contextual information). For example, suppose a user utilizes an application on the mobile computing device 100 that uses a significant amount of power (e.g., a video game or GPS application) every Wednesday at a particular time of day. In such a case, the power profiles may treat Wednesday differently from the other days of the week. Additionally or alternatively, as indicated above, the mobile computing device 100 may generate multiple power profiles (e.g., one for each day of the week, one for weekdays and another for the weekend, etc.) to accommodate consideration of the context of the mobile computing device 100 and/or its user.

In block 320, the mobile computing device 100 estimates the future power consumption of the mobile computing device 100 based on the power profiles and/or the power usage context. In doing so, the mobile computing device 100 may compare a long-term power profile (e.g., a historical power profile) to a short-term power profile (e.g., a daily power profile) in block 322. As discussed above, in the illustrative embodiment, the mobile computing device 100 generates a long-term power profile indicative of the average amount of energy remaining in the energy source 118 of the mobile computing device 100 at different times of day (i.e., a pattern of use of mobile computing device 100). Additionally, the mobile computing device 100 generates a short-term power profile indicative of the power usage (and, therefore, the remaining energy) of the mobile computing device 100 since a particular point in time (e.g., since the start of the day). The mobile computing device 100 compares the long-term power profile to the short-term power profile to identify any differences in power consumption throughout the day. Additionally, based on the power usage context, the mobile computing device 100 is able to detect other deviations from the typical pattern of usage (e.g., future scheduled events). The mobile computing device 100 analyzes the power profiles and the power usage context to estimate or predict a remaining energy level of the mobile computing device 102 at a future point in time.

In block 324 (see FIG. 4), the mobile computing device 100 determines whether to modify the power consumption of the mobile computing device 100. In other words, the mobile computing device 100 determines whether the current energy level of the mobile computing device 100 is sufficient to last until a predetermined future point in time without depleting (e.g., a recharge point in time—a typical time at which the user is home, a time that the user is estimated to arrive at home based on the context, etc.). It should be appreciated that, in some embodiments, the mobile computing device 100 estimates the future power consumption and determines whether to modify the power consumption of the mobile computing device 100 without utilizing power usage context information.

Referring now to FIGS. 6A and 6B, a long-term power profile 600 and a short-term power profile 602 are illustratively shown. Although the power profiles 600, 602 are shown as continuous power curves, it should be appreciated that the power profiles may be represented as discrete power values in other embodiments. The long-term power profile 600 indicates the average charge (i.e., energy) remaining in the energy source 118 of the mobile computing device 100 at different points throughout the day (i.e., in a twenty-four hour period). As shown, the mobile computing device 100 is fully charged during an interval 610 between midnight and the eighth hour (i.e., due to being connected to a charger overnight). At the eighth hour, the mobile computing device 100 is unplugged from the charger and in continuous use (i.e., discharging at a steady rate) over an interval 612 between the eighth hour and the seventeenth hour. During an interval 614 between the seventeenth and eighteenth hours, the mobile computing device 100 is charged (i.e., via a car charger while the user drives home from work). The mobile computing device 100 is removed from the charger at the eighteenth hour and continuously used during an interval 616 between the eighteenth hour and the twenty-second hour, at which point the mobile computing device 100 again begins to charge (i.e., via a home charger) until the twenty-fourth hour (i.e., during an interval 618). It should be appreciated that the rate of charge during the interval 618 is greater than the rate of charge during the interval 614 due to home chargers typically charging at a greater rate than vehicle chargers.

The short-term power profile 602 indicates the charge (i.e., energy) remaining in the energy source 118 of the mobile computing device 100 throughout the day up to a point in time at which the profile 602 is generated (i.e., the thirteenth hour). As with the long-term power profile 600, the short-term power profile 602 shows that the mobile computing device 100 is fully charged during an interval 620 between midnight and the eighth hour. As expected, the mobile computing device 100 was unplugged from the charger at the eighth hour and continuously used during an interval 622 between the eighth hour and the tenth hour. However, during an interval 624 between the tenth hour and the thirteenth hour, the energy of the mobile computing device 100 is discharged at a much greater rate than is typical (i.e., based on the comparison to the profile 600 during the period of time corresponding with the interval 624). During an analysis of the power profiles and the power usage context, the mobile computing device 100 projects/estimates the typical power usage during an interval 626 between the thirteenth hour to the seventeenth hour and determines that, without modifying the power consumption of the mobile computing device 100, the mobile computing device 100 will not last until the user arrives at home. Of course, in some embodiments, the mobile computing device 100 may determine (e.g., from the power usage context) that the user is likely to use less power throughout the remainder of the day and, because of that, no modifications to the power consumption are necessary.

Returning to FIG. 4, if the mobile computing device 100 determines to modify the power consumption in block 324, the mobile computing device 100 determines whether remedial action is still possible in block 326. That is, in some cases, the energy level of the mobile computing device 100 may reach a point at which nothing more can be done with respect to regulating the power consumption to ensure the charge lasts for a specified duration (e.g., until the end of the day) without recharging the mobile computing device 100. Accordingly, if the mobile computing device 100 determines that remedial action is not possible, the mobile computing device 100 alerts the user of the power status in block 328. For example, the mobile computing device 100 may transmit a message to the user indicating that the mobile computing device 100 must be charged or completely shut down for some period of time to last throughout a specified duration (e.g., until the end of the day). Of course, in some embodiments, the mobile computing device 100 may still attempt some remediation actions (e.g., regulate power consumption), in addition to the generation of the alert message.

If remedial action is still possible, the mobile computing device 100 regulates the power consumption of the mobile computing device 100 in block 330. In doing so, the mobile computing device 100 may modify (e.g., reduce) the power consumption of various components and/or features of the mobile computing device 100. As discussed above, the mobile computing device 100 may request the user of the mobile computing device 100 for input with respect to the components for which to modify the power consumption in block 332. Additionally or alternatively, the mobile computing device 100 may turn off ancillary devices in block 334, adjust the brightness of a display of the mobile computing device 100 in block 336, and/or modify a timeout period of a display of the mobile computing device 100 in block 338. Further, in some embodiments, the mobile computing device 100 may disable event alerts, terminate GPS unless in use for navigation, disable Wi-Fi, delay podcast downloads, and/or otherwise modify power consumption to reduce the overall power consumption of the mobile computing device 100. It should be appreciated that, in some embodiments, it may be necessary to slightly increase the power consumption of one component to decrease the power consumption of another component (e.g., by an amount of power that more than offsets the increase in power consumption) to reduce the overall power consumption of the mobile computing device 100.

Regardless of whether the mobile computing device 100 determines in block 324 not to modify power consumption (i.e., the current power levels are sufficient to last) or if the mobile computing device 100 regulates the power consumption in block 330, the mobile computing device 100 updates the power usage database 214 in block 340 with power usage data of the mobile computing device 100 (e.g., instantaneous power usage data). Additionally, in some embodiments, the mobile computing device 100 may update the power usage database 214 with one or more generated power profiles or results from analyses performed by the mobile computing device 100. After updating the power usage database 214, the method 300 returns to block 302 (see FIG. 3) in which the mobile computing device 100 determines whether to monitor power consumption. In other words, the method 300 is repeated. It should be appreciated that the method 300 may be performed by the mobile computing device 100 periodically, continuously, or according to another suitable temporal order depending on the particular embodiment. Additionally, in some embodiments, the mobile computing device 100 updates the power usage database 214 in parallel to performance of the method 300.

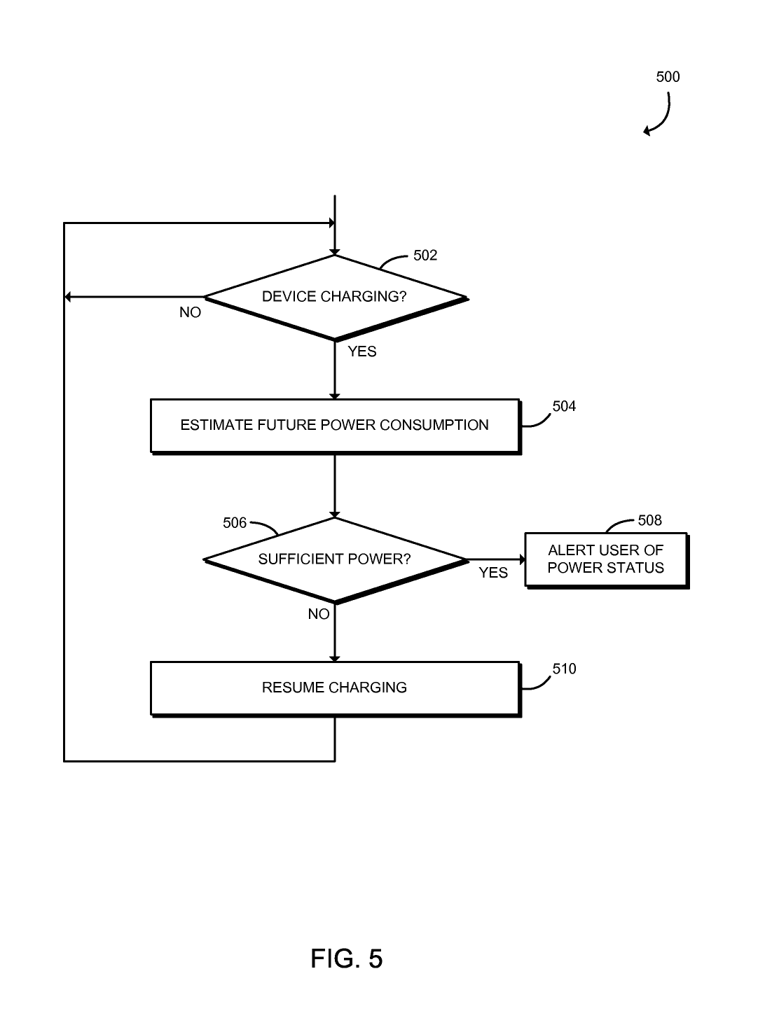

Referring now to FIG. 5, in use, the mobile computing device 100 may execute a method 500 for handling the charging of the mobile computing device 100. The illustrative method 500 begins with block 502 of FIG. 5 in which the mobile computing device 100 determines whether the mobile computing device 100 is charging. If so, the mobile computing device 100 estimates the future power consumption of the mobile computing device 100 in block 504. It should be appreciated that the mobile computing device 100 may do so in a similar manner to that described above with regard to the method 300. In block 506, the mobile computing device 100 determines whether it has sufficient power to last until a predetermined time or event (e.g., until the user is expected to arrive home). For example, such estimation may take into account the determined power usage context (e.g., are there any meetings or long teleconferences planned prior to arriving home or recharging of the mobile computing device 100). If not, the mobile computing device 100 resumes charging in block 510. However, if the mobile computing device 100 determines that the mobile computing device 100 has sufficient power, the mobile computing device 100 transmits an alert message to the user indicating such a state. As such, the user may remove the mobile computing device 100 from the charger rather than unnecessarily overcharge the mobile computing device 100 (e.g., so that the user may go home).

### EXAMPLES

Illustrative examples of the technologies disclosed herein are provided below. An embodiment of the technologies may include any one or more, and any combination of, the examples described below.

Example 1 includes a mobile computing device for regulating power consumption, the mobile computing device comprising a power estimation module to (i) generate a power profile based on historical power usage data of the mobile computing device, (ii) determine a power usage context of the mobile computing device, and (iii) estimate a future power consumption of the mobile computing device based on at least one of the power profile or the power usage context; and a power regulation module to regulate a power consumption of the mobile computing device based on the estimated future power consumption.

Example 2 includes the subject matter of Example 1, and wherein the power estimation module is further to retrieve the historical power usage data of the mobile computing device from a power usage database, wherein to generate the power profile comprises to generate the power profile in response to retrieval of the historical power usage data.

Example 3 includes the subject matter of any of Examples 1 and 2, and wherein to generate the power profile comprises to determine an average power consumption of the mobile computing device over a time period.

Example 4 includes the subject matter of any of Examples 1-3, and wherein to determine the power profile comprises to determine an average amount of energy remaining in an energy source of the mobile computing device at each of a plurality of times of day.

Example 5 includes the subject matter of any of Examples 1-4, and wherein to generate the power profile comprises to generate a first power profile of a historical pattern of energy usage of the mobile computing device; and wherein the power estimation module is further to generate a second power profile of energy usage of the mobile computing device since a point in time at which the mobile computing device was at full charge.

Example 6 includes the subject matter of any of Examples 1-5, and wherein to estimate the future power consumption comprises to compare the first power profile and the second power profile.

Example 7 includes the subject matter of any of Examples 1-6, and wherein to determine the power usage context comprises to analyze at least one of a schedule stored on the mobile computing device, a location of the mobile computing device, an activity performed on the mobile computing device, or an environmental condition of the mobile computing device.

Example 8 includes the subject matter of any of Examples 1-7, and further including a user interface module to transmit an alert message to a user of the mobile computing device in response to a determination that the mobile computing device must be charged to maintain power until a predetermined point in time.

Example 9 includes the subject matter of any of Examples 1-8, and wherein to regulate the power consumption comprises to request input from a user of the mobile computing device to identify one or more devices of the mobile computing device for which to modify power consumption.

Example 10 includes the subject matter of any of Examples 1-9, and wherein to regulate the power consumption comprises to at least one of turn off an ancillary device of the mobile computing device, adjust brightness of a display of the mobile computing device, or modify a timeout period of the display of the mobile computing device.

Example 11 includes the subject matter of any of Examples 1-10, and wherein the power estimation module is further to update a power usage database of the mobile computing device with instantaneous power usage data of the mobile computing device.

Example 12 includes the subject matter of any of Examples 1-11, and further including a user interface module to transmit an alert message to a user of the mobile computing device in response to a determination that the mobile computing device is charging and an energy source of the mobile computing has reached an energy level such that the mobile computing device has sufficient power to last until a predetermined point in time.

Example 13 includes the subject matter of any of Examples 1-12, and wherein to regulate the power consumption comprises to regulate the power consumption of the mobile computing device in response to the estimation of future power consumption indicating that the mobile computing device has insufficient power to last until a predetermined point in time.

Example 14 includes the subject matter of any of Examples 1-13, and wherein the predetermined point in time is a typical point in time at which the mobile computing device has determined, based on the historical power usage data, that the mobile computing device begins charging.

Example 15 includes a method for regulating power consumption on a mobile computing device, the method comprising generating, by the mobile computing device, a power profile based on historical power usage data of the mobile computing device; determining, by the mobile computing device, a power usage context of the mobile computing device; estimating, by the mobile computing device, a future power consumption of the mobile computing device based on at least one of the power profile or the power usage context; and regulating, by the mobile computing device, a power consumption of the mobile computing device based on the estimated future power consumption.

Example 16 includes the subject matter of Example 15, and further including retrieving the historical power usage data of the mobile computing device from a power usage database, wherein generating the power profile comprises generating the power profile in response to retrieving the historical power usage data.

Example 17 includes the subject matter of any of Examples 15 and 16, and wherein generating the power profile comprises determining an average power consumption of the mobile computing device over a time period.

Example 18 includes the subject matter of any of Examples 15-17, and wherein determining the power profile comprises determining an average amount of energy remaining in an energy source of the mobile computing device at each of a plurality of times of day.

Example 19 includes the subject matter of any of Examples 15-18, and wherein generating the power profile comprises generating a first power profile of a historical pattern of energy usage of the mobile computing device; and further comprising generating, by the mobile computing device, a second power profile of energy usage of the mobile computing device since a point in time at which the mobile computing device was at full charge.

Example 20 includes the subject matter of any of Examples 15-19, and wherein estimating the future power consumption comprises comparing the first power profile and the second power profile.

Example 21 includes the subject matter of any of Examples 15-20, and wherein determining the power usage context comprises analyzing at least one of a schedule stored on the mobile computing device, a location of the mobile computing device, an activity performed on the mobile computing device, or an environmental condition of the mobile computing device.

Example 22 includes the subject matter of any of Examples 15-21, and further including transmitting, by the mobile computing device, an alert message to a user of the mobile computing device in response to determining, by the mobile computing device, that the mobile computing device must be charged to maintain power until a predetermined point in time.

Example 23 includes the subject matter of any of Examples 15-22, and wherein regulating the power consumption comprises requesting input from a user of the mobile computing device to identify one or more devices of the mobile computing device for which to modify power consumption.

Example 24 includes the subject matter of any of Examples 15-23, and wherein regulating the power consumption comprises at least one of turning off an ancillary device of the mobile computing device, adjusting brightness of a display of the mobile computing device, or modifying a timeout period of the display of the mobile computing device.

Example 25 includes the subject matter of any of Examples 15-24, and further including updating, by the mobile computing device, a power usage database of the mobile computing device with instantaneous power usage data of the mobile computing device.

Example 26 includes the subject matter of any of Examples 15-25, and further including transmitting, by the mobile computing device, an alert message to a user of the mobile computing device in response to determining the mobile computing device is charging and an energy source of the mobile computing has reached an energy level such that the mobile computing device has sufficient power to last until a predetermined point in time.

Example 27 includes the subject matter of any of Examples 15-26, and wherein regulating the power consumption comprises regulating the power consumption of the mobile computing device in response to the estimation of future power consumption indicating that the mobile computing device has insufficient power to last until a predetermined point in time.

Example 28 includes the subject matter of any of Examples 15-27, and wherein the predetermined point in time is a typical point in time at which the mobile computing device has determined, based on the historical power usage data, that the mobile computing device begins charging.

Example 29 includes a computing device comprising a processor; and a memory having stored therein a plurality of instructions that when executed by the processor cause the computing device to perform the method of any of Examples 15-28.

Example 30 includes one or more machine-readable storage media comprising a plurality of instructions stored thereon that, in response to being executed, result in a computing device performing the method of any of Examples 15-28.

Example 31 includes a computing device for regulating power consumption, the computing device comprising means for performing the method of any of Examples 15-28.

1-25. (canceled)

26. A mobile computing device for regulating power consumption, the mobile computing device comprising:
a power estimation module to (i) generate a power profile based on historical power usage data of the mobile computing device, (ii) determine a power usage context of the mobile computing device, and (iii) estimate a future power consumption of the mobile computing device based on at least one of the power profile or the power usage context; and
a power regulation module to regulate a power consumption of the mobile computing device based on the estimated future power consumption.

27. The mobile computing device of claim 26, wherein the power estimation module is further to retrieve the historical power usage data of the mobile computing device from a power usage database, wherein to generate the power profile comprises to generate the power profile in response to retrieval of the historical power usage data.

28. The mobile computing device of claim 26, wherein to generate the power profile comprises to determine an average power consumption of the mobile computing device over a time period.

29. The mobile computing device of claim 28, wherein to determine the power profile comprises to determine an average amount of energy remaining in an energy source of the mobile computing device at each of a plurality of times of day.

30. The mobile computing device of claim 26, wherein to generate the power profile comprises to generate a first power profile of a historical pattern of energy usage of the mobile computing device; and
wherein the power estimation module is further to generate a second power profile of energy usage of the mobile computing device since a point in time at which the mobile computing device was at full charge.

31. The mobile computing device of claim 30, wherein to estimate the future power consumption comprises to compare the first power profile and the second power profile.

32. The mobile computing device of claim 26, wherein to determine the power usage context comprises to analyze at least one of a schedule stored on the mobile computing device, a location of the mobile computing device, an activity performed on the mobile computing device, or an environmental condition of the mobile computing device.

33. The mobile computing device of claim 26, further comprising a user interface module to transmit an alert message to a user of the mobile computing device in response to a determination that the mobile computing device must be charged to maintain power until a predetermined point in time.

34. The mobile computing device of claim 26, wherein to regulate the power consumption comprises to request input from a user of the mobile computing device to identify one or more devices of the mobile computing device for which to modify power consumption.

35. The mobile computing device of claim 26, wherein to regulate the power consumption comprises to at least one of turn off an ancillary device of the mobile computing device, adjust brightness of a display of the mobile computing device, or modify a timeout period of the display of the mobile computing device.

36. The mobile computing device of claim 26, wherein the power estimation module is further to update a power usage database of the mobile computing device with instantaneous power usage data of the mobile computing device.

37. The mobile computing device of claim 26, further comprising a user interface module to transmit an alert message to a user of the mobile computing device in response to a determination that the mobile computing device is charging and an energy source of the mobile computing has reached an energy level such that the mobile computing device has sufficient power to last until a predetermined point in time.

38. The mobile computing device of claim 26, wherein to regulate the power consumption comprises to regulate the power consumption of the mobile computing device in response to the estimation of future power consumption indicating that the mobile computing device has insufficient power to last until a predetermined point in time.

39. The mobile computing device of claim 38, wherein the predetermined point in time is a typical point in time at which the mobile computing device has determined, based on the historical power usage data, that the mobile computing device begins charging.

40. One or more machine-readable storage media comprising a plurality of instructions stored thereon that, in response to execution by a mobile computing device, causes the mobile computing device to:
generate a power profile based on historical power usage data of the mobile computing device;
determine a power usage context of the mobile computing device;
estimate a future power consumption of the mobile computing device based on at least one of the power profile or the power usage context; and
regulate a power consumption of the mobile computing device based on the estimated future power consumption.

41. The one or more machine-readable storage media of claim 40, wherein to generate the power profile comprises to determine an average power consumption of the mobile computing device over a time period.

42. The one or more machine-readable storage media of claim 40, wherein to generate the power profile comprises generating a first power profile of a historical pattern of energy usage of the mobile computing device;
wherein the plurality of instructions further causes the mobile computing device to generate a second power profile of energy usage of the mobile computing device since a point in time at which the mobile computing device was at full charge; and
wherein to estimate the future power consumption comprises to compare the first power profile and the second power profile.

43. The one or more machine-readable storage media of claim 40, wherein to determine the power usage context comprises to analyze at least one of a schedule stored on the mobile computing device, a location of the mobile computing device, an activity performed on the mobile computing device, or an environmental condition of the mobile computing device.

44. The one or more machine-readable storage media of claim 40, wherein to regulate the power consumption comprises to at least one of turn off an ancillary device of the mobile computing device, adjust brightness of a display of the mobile computing device, or modify a timeout period of the display of the mobile computing device.

45. The one or more machine-readable storage media of claim 40, wherein the plurality of instructions further causes the mobile computing device to update a power usage database of the mobile computing device with instantaneous power usage data of the mobile computing device.

46. The one or more machine-readable storage media of claim 40, wherein to regulate the power consumption comprises to regulate the power consumption of the mobile computing device in response to the estimation of future power consumption indicating that the mobile computing device has insufficient power to last until a predetermined point in time.

47. A method for regulating power consumption on a mobile computing device, the method comprising:
generating, by the mobile computing device, a power profile based on historical power usage data of the mobile computing device;
determining, by the mobile computing device, a power usage context of the mobile computing device;
estimating, by the mobile computing device, a future power consumption of the mobile computing device based on at least one of the power profile or the power usage context; and
regulating, by the mobile computing device, a power consumption of the mobile computing device based on the estimated future power consumption.

48. The method of claim 47, wherein generating the power profile comprises determining an average amount of energy remaining in an energy source of the mobile computing device at each of a plurality of times of day.

49. The method of claim 47, wherein generating the power profile comprises generating a first power profile of a historical pattern of energy usage of the mobile computing device; and further comprising:
generating, by the mobile computing device, a second power profile of energy usage of the mobile computing device since a point in time at which the mobile computing device was at full charge; and
wherein estimating the future power consumption comprises comparing the first power profile and the second power profile.

50. The method of claim 47, wherein regulating the power consumption comprises regulating the power consumption of the mobile computing device in response to the estimation of future power consumption indicating that the mobile computing device has insufficient power to last until a predetermined point in time.
